(19) United States
(12) Patent Application Publication
(10) Pub. No.: US 2026/0303217 A1
(43) Pub. Date: Oct. 1, 2026

(54) BI-DIRECTIONAL DENSE WAVELENGTH MULTIPLEXED OPTICAL COMMUNICATION SYSTEMS

(71) Applicant: Quintessent Inc., Goleta, CA (US)

(72) Inventors: Alan LIU, Santa Barbara, CA (US); Brian KOCH, Santa Barbara, CA (US); Christopher R. COLE, Redwood City, CA (US); Steven Brian ESTRELLA, Santa Barbara, CA (US); John GARCIA, Santa Barbara, CA (US)

(21) Appl. No.: 19/631,421

(22) Filed: Mar. 27, 2026

Related U.S. Application Data
(60) Provisional application No. 63/779,733, filed on Mar. 28, 2025.

(51) Int. Cl. H04B 10/40; H04B 10/25; H04B 10/50; H04B 10/61; H04Q 11/00

(52) U.S. Cl. CPC H04B 10/40; H04B 10/2589; H04B 10/503; H04B 10/506; H04B 10/614; H04Q 11/0005; H04Q 2011/0016; H04Q 2011/0018

(57) ABSTRACT

A bidirectional optical transceiver includes a transmitter module having at least one dense wavelength division multiplexed (DWDM) optical comb laser source, optical modulators configured to modulate respective DWDM wavelength channels and a receiver module. The receiver module includes wavelength-selective optical filters matched to the DWDM wavelength channels, photodetectors optically coupled to respective ones of the wavelength-selective optical filters, an optical interface port configured for optical coupling to an optical fiber, and a diplexer optically coupled between the transmitter and receiver module, and the optical interface port. The diplexer directs optical signals propagating in a first direction on the optical fiber to the receiver module and directs optical signals generated by the transmitter module to propagate in the opposite direction on the optical fiber. The transmitter module and the receiver module operate on different sets of DWDM wavelength channels such that bidirectional optical communication is supported over the single optical fiber.

### CROSS REFERENCE TO RELATED APPLICATION

This application claims the benefit of U.S. Provisional Application No. 63/779,733. The contents of the provisional applications noted above are incorporated herein by reference.

### BACKGROUND

Data range (DR) optics technology is widely deployed in data centers and leverages parallel single-mode (PSM) fiber to enable high-speed data transmission for reaches up to 500 m. Each DR-optics-based link consists of a pair of fibers, where one fiber is used exclusively for transmit and the other fiber is used exclusively for receive. Given the physical separation of transmit and receive transmission onto two fibers, DR optics use a single (common) wavelength for communication.

Bidirectional (Bi-Di) technology refers to the capability of transmitting and receiving data simultaneously over the same optical fiber. This technology enhances the efficiency and capacity of optical communication systems by enabling bi-directional communication along a single strand of fiber. Bi-Di systems typically use wavelength division multiplexing (WDM) techniques, allowing different wavelengths of light to carry data in both directions simultaneously. With this approach, Bi-Di technology optimizes the utilization of available optical infrastructure and lowers overall costs.

Typical intra-data center optical interconnects rely on PSM fiber pairs to establish the transmit (Tx) and receive (Rx) pathways, utilizing the same optical wavelength in physically separated fibers, such as in DR optics. In DR optics configurations, implementing WDM requires a fiber pair for each wavelength, and is therefore costly to increase spectral bandwidth. Initial implementations of WDM for Bi-Di within data centers leveraged widely spaced wavelengths in multi-mode fiber (MMF) for the Tx and Rx paths. WDM Bi-Di is also found in passive optical networks (PON) for 5G/6G wireless and FTTx applications, where ~1310 nm wavelengths are used for upstream communication and ~1550 nm wavelengths are used downstream. True WDM Bi-Di (i.e., Tx and Rx are the same wavelength and on the same fiber) has recently been implemented in the data center in conjunction with optical circuit switching (OCS), by implementing optical circulators to separate the Tx and Rx paths. This implementation is costly as optical circulators are required, great care must be taken to reduce optical reflections in the fiber plant-including the use of angle-polished connectors and laser sources with co-packaged optical isolators-further adding to cost and optical loss, and finally, digital signal processing (DSP) must be implemented to remove any residual multi-path interference (MPI). Noteworthy was the implementation of 8 coarse WDM (CWDM-8) within an 80 nm spectral range, deviating from industry standard CWDM-4 with 4 wavelengths in 80 nm, in order to increase bandwidth. A more cost-effective method to increase bandwidth without increasing fiber pairs for WDM Bi-Di is needed to address future data center needs.

### SUMMARY

In accordance with one aspect of the present disclosure, an optical system comprises at least two nodes, with each node containing a transmitter and receiver, that operates bi-directionally using dense wavelength division multiplexing (DWDM). Each transmitter is formed by employing a DWDM multi-wavelength comb laser and an accompanying array of micro-ring modulators (MRM) with matched channel spacing and resonant wavelengths as the comb laser. Each receiver is formed by an array of photodiodes coupled to DWDM optical bandpass filters, whereby the DWDM filters are matched in wavelength to the transmitter comb laser. Furthermore, the DWDM comb laser in each transmitter node within the optical system uses different wavelength channels (e.g., CWDM or offset DWDM), thereby increasing the available bandwidth compared to conventional arrangements. The resulting transmitter and receiver—at a particular node within the optical system—are each tuned to a different set of wavelength channels and are optically combined into one optical fiber using a multiplexer/de-multiplexer element, providing a lower cost and potentially more robust solution than employing an optical circulator. Therefore, the described optical system can achieve bi-directional operation using a distinct set of DWDM channels for each direction and provide significantly higher bandwidth over conventional arrangements.

Furthermore, by integrating the different DWDM comb lasers into the same transmitter, multiple optical system benefits can be achieved. First, the same resulting transceiver type can be employed at both end nodes, negating the need for a type “A” at one node and a type “B” at the other—whereby type “A” and “B” correspond to different DWDM channel sets—which reduces system cost. Second, if one DWDM comb laser fails in a particular transmitter, the other DWDM comb laser serves as a redundant spare and can be activated to maintain optical system operation, which increases system reliability.

In one embodiment, transceiver (transmitter and receiver) type “A” includes a transmitter tuned to one set of DWDM channels and the receiver tuned to the other set of DWDM channels. The transmitter and receiver are coupled together with an optical multiplexer/demultiplexer. Then, transceiver type “B” consists of a receiver tuned to type “A” transmitter DWDM channels, while the transmitter is tuned to type “B” receiver DWDM channels. This embodiment requires the use of a unique stock keeping unit (SKU) number for each transceiver type, increasing system cost and providing no additional redundancy for increased reliability.

In another embodiment, each transceiver includes both type “A” and type “B” transmitters and receivers, providing a single SKU number and full redundancy, but doubles the amount of hardware and circuitry.

In another embodiment, a single transceiver type can be realized whereby the DWDM comb lasers are multiplexed together and share a common array of MRMs to formulate the transmitter block, while the receiver block is comprised of a single set of photodiodes and optical bandpass filters, and the transmitter and receiver blocks are coupled together with an appropriate multiplexer/demultiplexer.

In one embodiment, the DWDM comb laser centers can be widely spaced according to the coarse WDM (CWDM) wavelength plan of ~20 nm or ~10 nm. However, this implementation may require more than one laser gain material type for adequate wavelength coverage, the use of CWDM multiplexer to couple both lasers together, and a CWDM multiplexer/demultiplexer to couple the transmit and receive blocks together. In another embodiment, the DWDM comb lasers are spaced by the same DWDM channel spacing (e.g., 100, 200 or 400 GHz)

In another embodiment, a single DWDM comb laser type is employed in the transmitter, whereby different sets of DWDM channels are achieved by offset tuning one laser relative to the other (e.g., offset by 50% of channel spacing). While this same transceiver configuration can be used at both nodes and yields a single SKU number, the DWDM comb laser channel spacing must be chosen appropriately to accommodate spacing between the DWDM comb lasers and the data modulation on each channel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A shows an embodiment of two photonic integrated circuits (PICs) that form a bidirectional transceiver pair; FIG. 1B schematically provides a functional description of the multiplexing/demultiplexing functionality of the diplexer shown in FIG. 1 when implemented via asymmetric Mach-Zehnder interferometers (AMZIs); FIG. 1C shows the wavelength response characteristics of the diplexer when formed from an AMZI using either first- or higher-order filter structures; FIG. 1D schematically provides a functional description of the multiplexing/demultiplexing functionality of the diplexer shown in FIG. 1 when implemented as a passive contra-directional filter (CDF); and FIG. 1E qualitatively shows the wavelength response of an embodiment employing a CDF in which data can be transmitted utilizing adjacent wavelength bands.

FIG. 2 illustrates an alternative embodiment of the bidirectional transceiver pair.

FIG. 3 illustrates yet another alternative embodiment of the bidirectional transceiver pair.

FIGS. 4A, 4B and 4C show alternative embodiments of the bidirectional transceiver pair.

FIG. 5-8 illustrate additional embodiments of the bidirectional transceiver pair.

FIG. 9A shows an embodiment of the bidirectional transceiver pair in which the laser comb source is situated external to the transceiver PICs.

FIG. 9B shows different examples of the external laser comb source shown in FIG. 9A.

### DETAILED DESCRIPTION

In the following description and figures identical or functionally similar elements are designated by the same reference numerals. Further, when multiple instances of identical or functionally similar elements are depicted, such elements are designated using the same reference numeral with distinct subscripts to differentiate the respective instances.

In one aspect, the present disclosure relates to an optical system that is formulated between two or more transceiver nodes, where each transceiver node comprises a transmitter and receiver, which operates bidirectionally and utilizes dense wavelength division multiplexing (DWDM) for high bandwidth communication. Each set of DWDM wavelengths are centered in disparate coarse wavelength division multiplexed (CWDM) bands.

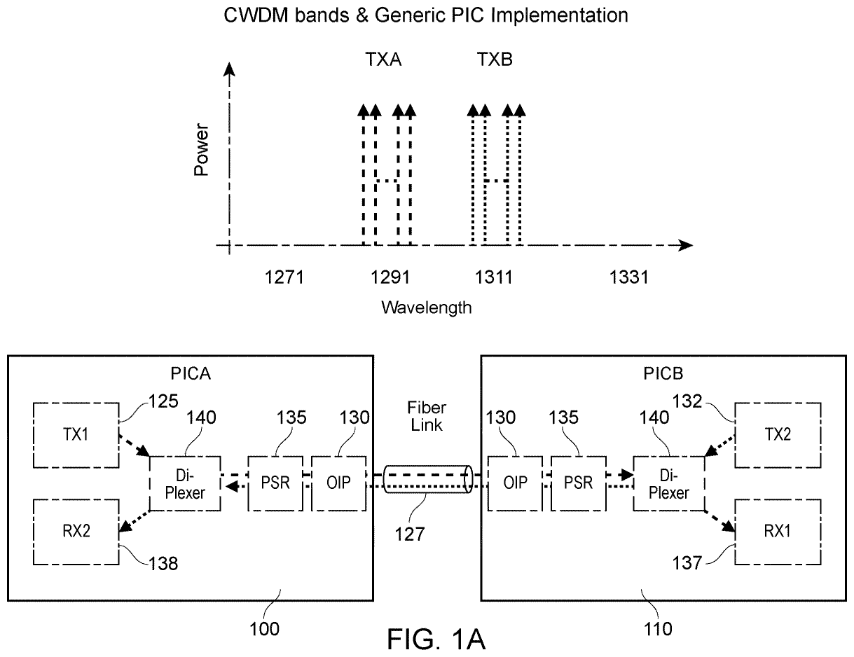

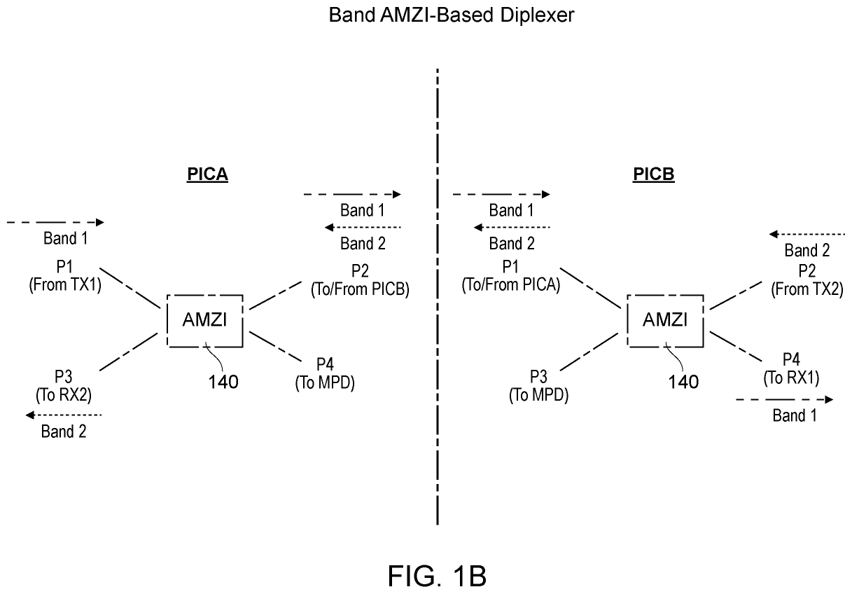

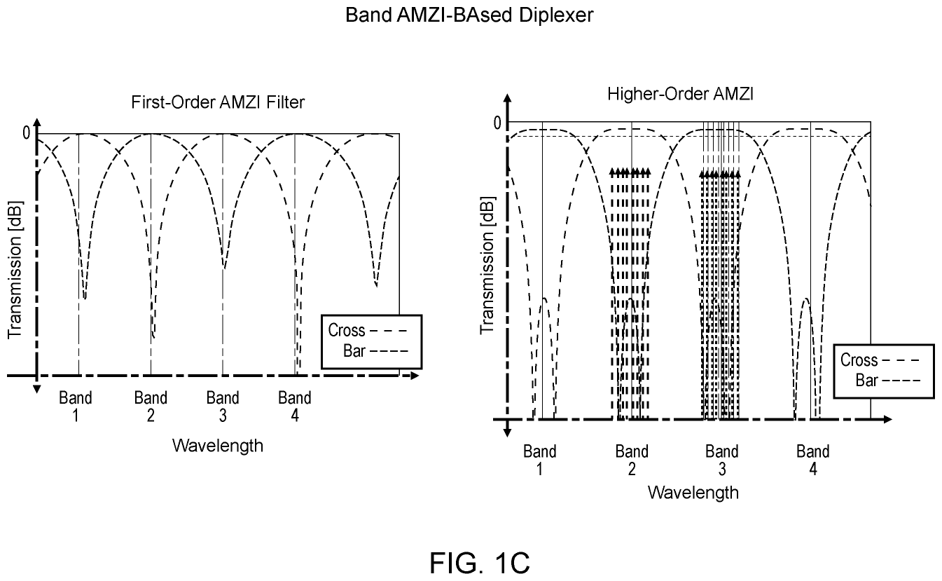

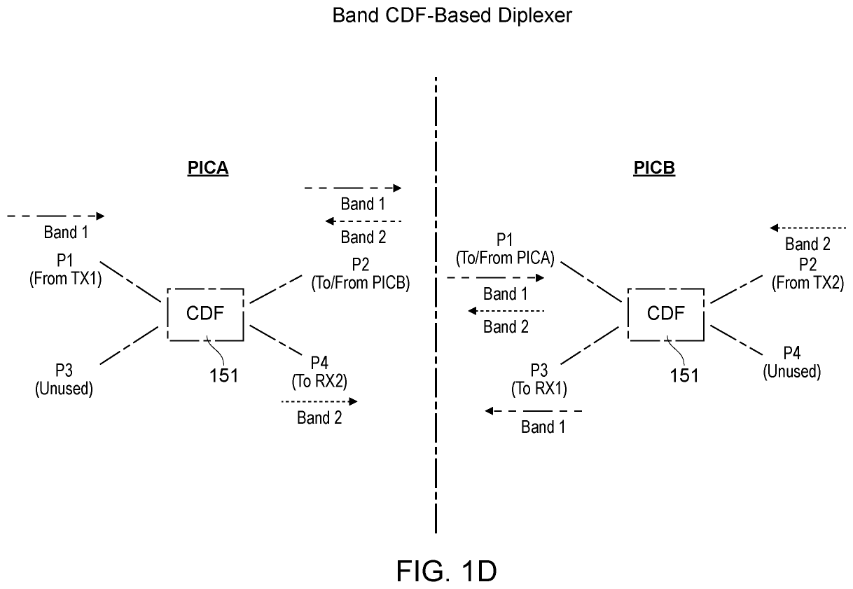

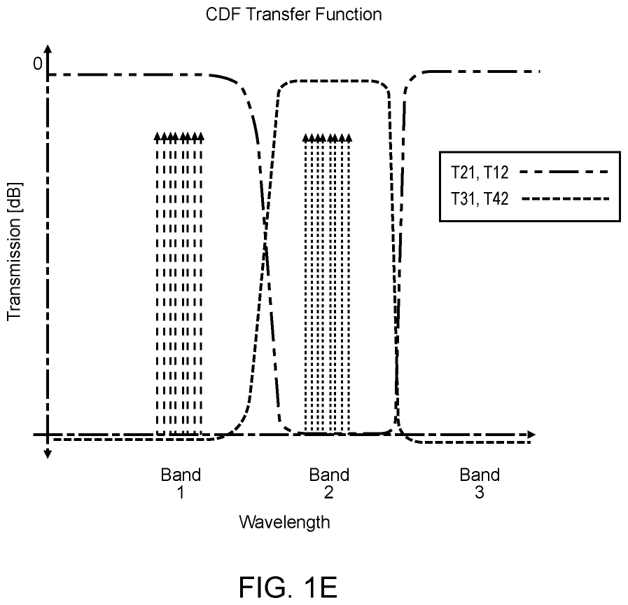

FIG. 1A shows an embodiment of two photonic integrated circuits (PICs), denoted “PICA 100” and “PICB 110,” in a bidirectional configuration connected via a single optical fiber. In this configuration optical signals from transmitter TX1 125 are routed to receiver RX1 137 via a diplexer that spatially separates left-to-right traffic from right-to-left traffic as long as the counter-propagating signals are on separate wavelength bands. Similarly, optical signals are routed from TX2 132 to RX2 138. The following illustrative wavelength plans also may be supported:
a) TX1/RX1 and TX2/RX2 centered about any disparate CWDM4 band (1271, 1291, 1311, 1331) separated by 20 nm;
b) TX1/RX1, TX2/RX2, TX3/RX3, TX4/RX4 centered about any disparate CWDM4 band (1271, 1291, 1311, 1331) separated by 20 nm;
c) TX1/RX1 and TX2/RX2 centered about any disparate CWDM8 band (1271, 1281, . . . , 1341) separated by 10 nm;
d) TX1/RX1, TX2/RX2, . . . , TX8/RX8 centered about any disparate CWDM8 band (1271, 1281, . . . , 1331) separated by 10 nm.

In the embodiment of FIG. 1A, TX1 125 of PICA 100 includes a multi-wavelength comb laser and an array of electro-optical modulators. The multi-wavelength comb laser is used as the DWDM optical source in the transmitter block and may be fabricated using, for example, methods described in U.S. Pat. No. 12,046,871 (which is hereby incorporated by reference in its entirety), where the active semiconductor material may be a group III-V compound such as GaAs, and where the passive semiconductor material may be a group IV material such as Si or SiN. In some cases, the comb laser may be designed to provide output wavelengths compliant with a DWDM optical grid defined with 100 GHz, 200 GHz or 400 GHz channel spacing. Additionally, each individual laser output may be configured so that it is centered in accordance with a CWDM4 wavelength grid (1271 nm, 1291 nm, 1311 nm, 1331 nm) separated by 20 nm. Alternatively, each individual laser output may be configured so that it is centered in accordance with a CWDM8 wavelength grid (1271 nm, 1281 nm, . . . , 1341 nm) separated by 10 nm.

The array of electro-optic modulators (EOM) and optical bandpass filters electrically encode information onto each of the individual DWDM optical carriers. The modulator array may be implemented in a variety of different ways. For instance, in one embodiment, an array of micro-ring modulators (MRM) is used to form the array of EOMs and optical bandpass filters, with each MRM optical resonance matched to a corresponding DWDM comb laser line. In another embodiment, an array of Mach-Zehnder modulators (MZM) is used to form the EOMs, where an input optical demultiplexer and output multiplexer may be used as the optical bandpass filtering elements, with added loss contributed by the optical multiplexer/demultiplexer. In another embodiment, the array of MZMs can be replaced by electro-absorption modulators (EAM).

The receive portion of each PIC includes an optical interface port (OIP) 130, a polarization splitter and rotator (PSR) 135, and a receiver block RX1 137 in PICB 110 and RX2 138 in PICA 100. The OIP 130 is utilized to allow optical signals to exit the transmit PIC and enter the receive PIC via a fiber link 127 that may consist of single-mode fiber (SMF). As optical signals traverse the SMF link 127, the polarization state may become scrambled and randomized. The PSR 125 accounts for this polarization diversity by 1) spatially separating an input optical signal's constituent polarization states and 2) performing polarization rotation such that all on-chip light is polarized in the transverse electric (TE) state. The OIP and PSR may be implemented in a variety of different ways in a Si or SiN platform. For example, in one embodiment, the OIP 130 is implemented as a diced and polished end facet while the PSR 135 is implemented in a manner similar to what is described in Wesley D. Sacher, Tymon Barwicz, Benjamin J. F. Taylor, and Joyce K. S. Poon, “Polarization rotator-splitters in standard active silicon photonics platforms,” Opt. Express 22, 3777-3786 (2014). In another embodiment, the OIP 130 is implemented as an etched end facet while the PSR 135 is implemented in a manner similar to what is described in Wesley D. Sacher, Tymon Barwicz, Benjamin J. F. Taylor, and Joyce K. S. Poon, “Polarization rotator-splitters in standard active silicon photonics platforms,” Opt. Express 22, 3777-3786 (2014). In another embodiment, the combined functionality of the OIP 130 and PSR 135 is implemented via a two-dimensional grating coupler similar to what is described in Chen, X. Zhang, J. Hu, Y. Zhu, X. Cai, P. Chen, and L. Liu, “Two-dimensional grating coupler on silicon with a high coupling efficiency and a low polarization-dependent loss,” Opt. Express 28, 4001-4009 (2020).

In the receive direction, the OIP and PSR essentially spatially separate the TE and TM components from a randomly polarized signal into separate waveguide ports. This typically requires two sets of receive photonic components that correspond to each receive polarization path.

RX1 137 and RX2 138 each include an array of photodetectors, each one preceded by an optical bandpass filter that is matched to a corresponding DWDM comb laser line (as mentioned in U.S. patent application Ser. No. 18/098,568).

The optical transceiver system illustrated in FIG. 1A and the subsequent figures may be implemented using any of several approaches, including: (a) an implementation employing discrete, fiber-coupled, and individually packaged optical components; (b) an implementation based on a photonic integrated circuit (PIC) platform, as depicted in FIG. 1A, configured to realize the entire transceiver node, including a DWDM comb laser, active modulators and photodetectors, and passive waveguide as well as multiplexing, demultiplexing, and filtering elements; or (c) an implementation utilizing a combination of discrete and PIC components that are either individually packaged or co-packaged together.

In some embodiments depicted in the figures, TX1 125 and RX2 138 may be optically coupled together with a wavelength selective diplexer 140 in lieu of optical isolators and/or circulators, which are lossy, bulky, and require integration of either a permanent magnet or exotic latched garnet material. The wavelength selective diplexer 140 is implemented as a four-port component that is utilized to spatially separate CWDM4 or CWDM8 wavelengths bands traveling in opposite directions. This photonic component can be realized via different approaches, two examples of which are described below.

In one embodiment, the wavelength selective diplexer 140 can be implemented using asymmetric Mach-Zehnder interferometers (AMZIs) whose index of refraction could be tuned thermally. FIG. 1B schematically provides a functional description of the multiplexing/demultiplexing functionality when implemented via AMZIs. As shown, AMZI 140 in PICA transmits data encoded onto Band-1 through port P1 and receives data encoded into Band-2 via port P3. Port P2 allows Band-1 data to be forwarded to PICB while simultaneously receiving Band-2 optical signals from PICB. In this scenario, Band-1 and -2 signals are traveling in the opposite directions through a common waveguide. Port 4 could be terminated with a monitor photodiode (MPD) that may be utilized for the purposes of monitoring and configuration. This MPD could be utilized to ensure that Band-2 transmission to port P3 is maximized while suppressing transmission to port P1. Conversely, transmission of Band-1 signals from port P1 to port P2 are maximized while suppressing transmission to port P4. The diplexer formed from AMZI 140 can be implemented using either first- or higher-order filter structures with wavelength response characteristics similar to what is shown in FIG. 1C. In this implementation, the bidirectional transceiver may be designed to utilize either adjacent or non-adjacent bands to send and receive data.

In another embodiment, the diplexer 140 is implemented as a passive contra-directional filter (CDF) as described, for example, in U.S. patent application Ser. No. 18/414,727. The functional configuration of this implementation is schematically shown for the CDF 151 in FIG. 1D. In this configuration, port P3 in PICA is not utilized, while port P4 is routed to the corresponding Rx Block. Similarly, port P4 in PICB is unused while port P3 is routed to its corresponding RX Block. FIG. 1E qualitatively shows the wavelength response of an embodiment employing a CDF in which data can be transmitted utilizing adjacent wavelength bands (1 and 2 or 2 and 3). This arrangement offers the advantage of being a completely passive device that does not require tuning.

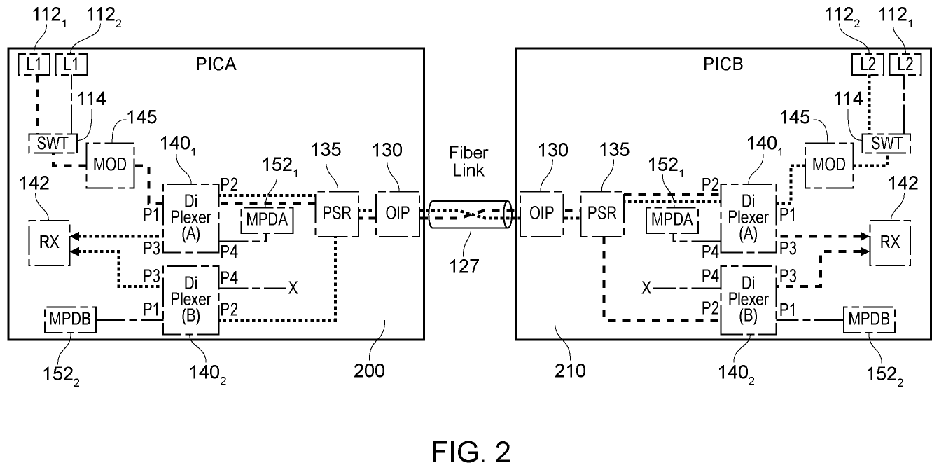

FIG. 2 illustrates an additional embodiment of a bidirectional transceiver pair, identified as PICA 200 and PICB 210. As previously noted, in FIGS. 1 and 2, as well as in the figures that follow, identical or functionally similar elements are designated by the same reference numerals. Accordingly, the description of the transceiver pair with reference to FIG. 2 and the subsequent figures omits detailed discussion of components that have been previously described.

PICA 200 includes two lasers 112₁ and 112₂ that are each centered at Band-1 (L1) that are used as input to an optical 2-to-1 switch 114 (implemented, e.g., as a thermally tuned MZI) before being forwarded to the modulator array (MOD) 145. In this implementation, only one laser is enabled at any given time, which serves as a means of increasing PIC reliability via laser redundancy. The diplexers 140₁ and 140₂ are implemented via a pair of AMZIs or a pair of CDFs (one for each PSR output polarization path). In the receive path, incoming light in the TE and TM polarization states is received by the PSR 135. The TE light is directed to one of the diplexers and the TM light is rotated to the TE polarization state by the PSR 135 and directed to the other diplexer. The diplexers 140₁ and 140₂ then direct the light to RX 142, which recombines them. The diplexer 140₁ is configured to maximize transmission from the lasers to the PSR 135, which also maximizes the back-propagating transmission from the PSR 135 to RX 142 for signals in Band-2. Similarly, diplexer 140₂ is configured to maximize Band-2 transmission from the PSR to RX 142. An MPDA 152₁ is located on port 4 of diplexer 140₁ and MPDB 152₂ is located on port 1 of diplexer 140₂. PICB 210 is similar to PICA 200 with the exception of having its lasers centered using Band-2 wavelengths.

The embodiment shown in FIG. 2 exhibits a number of benefits. For instance, bidirectional transmission is achieved without use of an isolator, which minimizes packaging costs and excess insertion loss. Also, the use of different bands for transmit versus receive allows the effects of MPI to be minimized compared to an implementation utilizing identical transmit and receive wavelengths. Any Band-1 reflections back into PICA 200 are routed towards MPDB 210 or towards laser L1 112. The latter should exhibit a fair amount of optical feedback tolerance enabled by the active region consisting of low alpha factor quantum dot (QD) epitaxial material. Another advantage of the embodiment shown in FIG. 2 is that the laser redundancy provides enhanced reliability. Additionally, the same modulator array and receiver block can be utilized (with slight tuning) for both primary and secondary laser configurations. A potential drawback associated with the embodiment shown in FIG. 2 is that it requires distinct stock-keeping units (SKUs) to be assigned to PICA 200 and PICB 210, which may increase inventory complexity. Additionally, depending on the specific configuration, signal reflections from the transmitting components into the receiving components block may occur due to the shared use of diplexer—140₁ between the two sets of components, potentially affecting system performance.

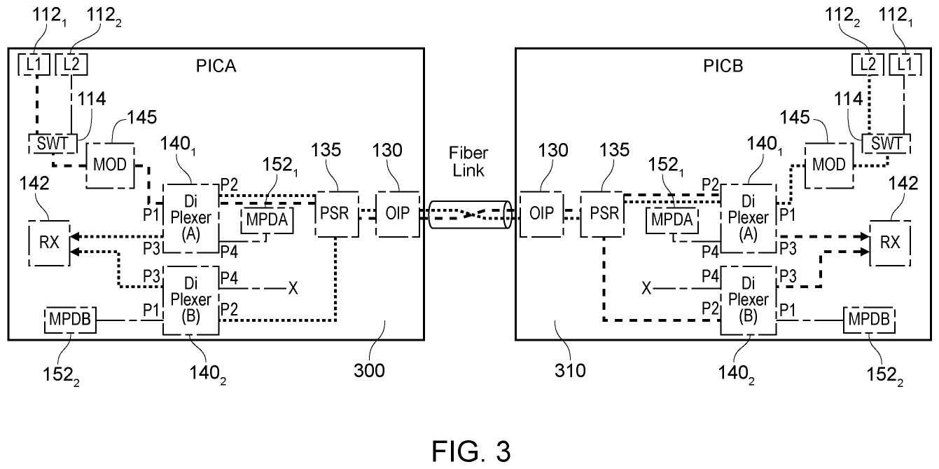

In another embodiment, as illustrated in FIG. 3, selection between a Band-1 laser L1 112₁ and a Band-2 laser L2 112₂ may be achieved using a 2:1 optical switch, which may be implemented, for example, by a thermally tunable Mach-Zehnder interferometer (MZI). To enable band swapping, the diplexer may be implemented using an asymmetric Mach-Zehnder interferometer (AMZI) architecture configured to be tuned by a phase shift of φ=π to preserve bidirectional operation. This approach may provide several advantages. First, a single stock-keeping unit (SKU) may be used for each transceiver pair, thereby simplifying manufacturing and logistics. Second, reliability may be enhanced through laser redundancy; for example, if the Band-1 laser L1 112₁ on PICA 300 fails, the photonic integrated circuit (PIC) may be reconfigured to transmit using the Band-2 laser L2 112₂, whose dense wavelength division multiplexing (DWDM) output is centered in Band-2, while PICB 310 may be correspondingly reconfigured to transmit using its Band-1 laser L112₁. Third, the same modulator array and receivers may be repurposed following a band swap, which may simplify reconfiguration, although this may impose constraints on the allowable wavelength separation between Band-1 and Band-2 to ensure that the modulator and the receiver components provide sufficient broadband performance without requiring substantial retuning. In implementations where these elements are based on ring resonators, the free spectral range of the resonators may be selected to match the band spacing so that minimal tuning is required when switching between bands.

Some potential drawbacks associated with the embodiment shown in FIG. 3 may be that wavelength band swapping requires network level awareness to instruct the functional transceiver counterpart to also perform a wavelength band swap.

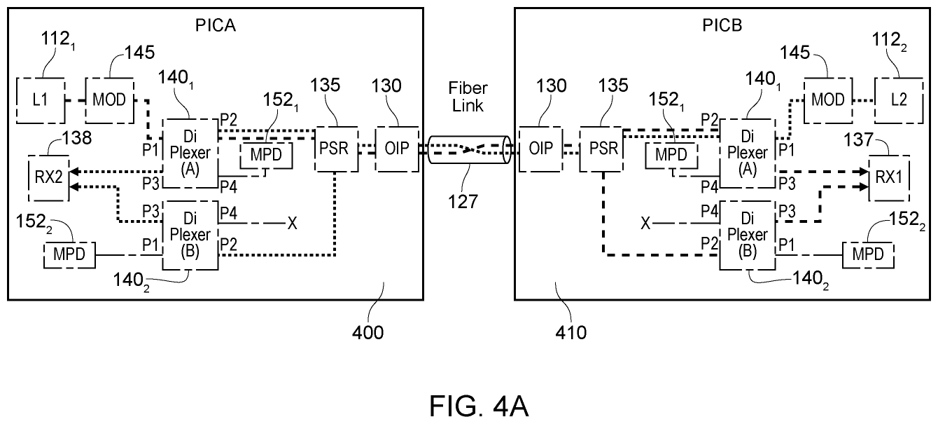

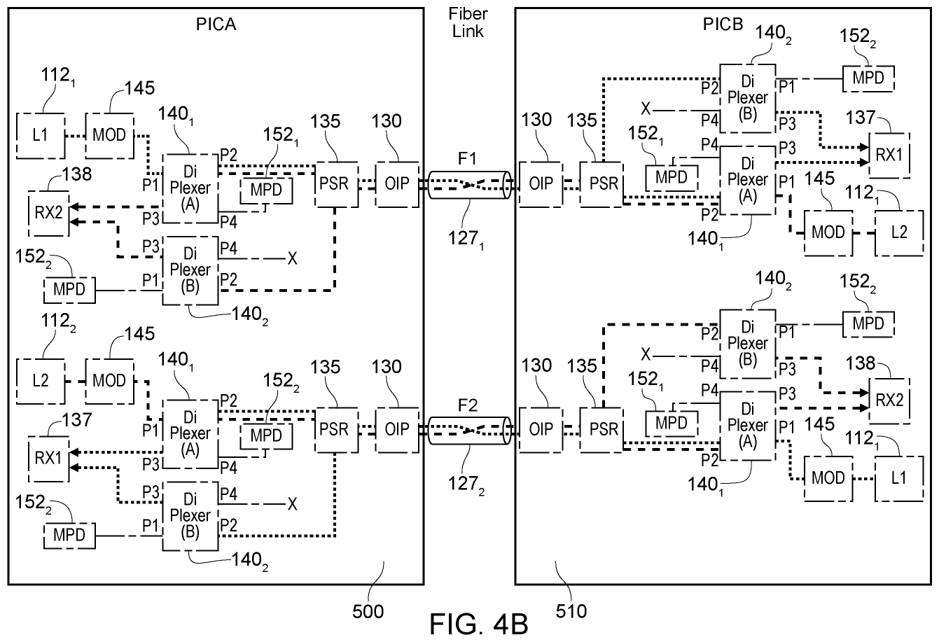

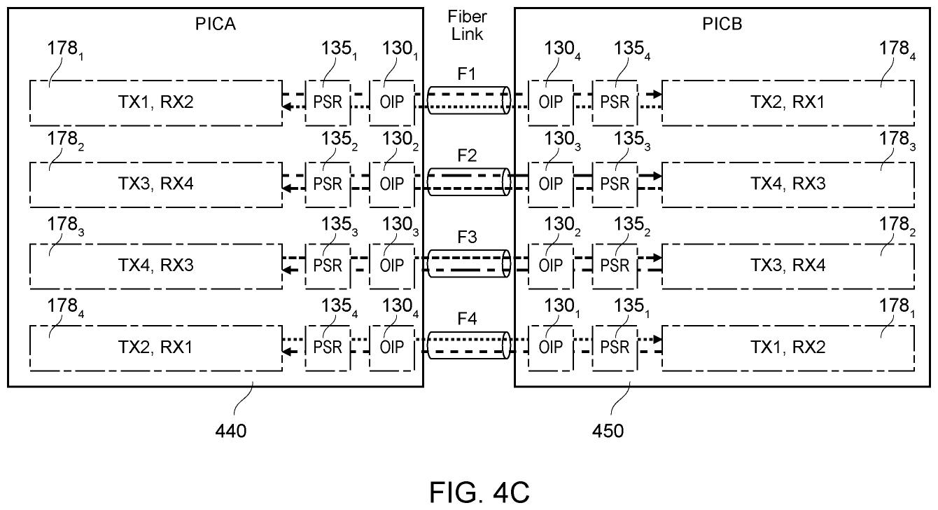

FIG. 4A shows another embodiment, of the bidirectional transceiver in accordance with the present disclosure. This is a simplified version of the architecture that does not include laser redundancy. A benefit of this implementation is that it simplifies the PIC layout, which minimizes die area, potentially improves yield, and simplifies the associated laser control electronics. This approach requires unique SKUs for each PIC and the architecture does not provide laser redundancy.

In another embodiment, the bidirectional transceiver architecture is designed to include both sets of Band-1 and -2 transceiver pairs. As shown in FIG. 4B, this allows the architecture of FIG. 4A to be scaled twofold to double the aggregate transmit bandwidth from a single PIC via two separate fiber links. Data is transmitted on fiber link F1 127₁ and received using Band-1 and -2, respectively. On fiber link F2, the transmit and receive wavelength bands are swapped on fiber link F2 127₂. This scaled transceiver architecture can be implemented via a common SKU for both PICs. This architecture is interoperable with transceivers similar to FIG. 4A, which could simplify the upgrade process where two single-fiber transceivers on the same rack can be incrementally swapped out for a single transceiver supporting this dual-fiber configuration. This configuration can be scaled to configurations with any even number of transmit/receive ports.

FIG. 4C shows another embodiment in which the bidirectional transceiver architecture is further scaled to include all four bands of CWDM4 as transmit and receive pairs 178₁-178₄. In this embodiment PICA 440 and PICB 450 are the same, but rotated with respect to one another. The fiber pairing shown in FIG. 4C does not cross fibers. This PIC architecture quadruples the aggregate data bandwidth relative to the FIG. 4A architecture. Furthermore, this allows DWDM bidirectional data to be transmitted using a 4-fiber bundle, which may prove useful in scenarios that could benefit from upgrading DR4 hardware without having to also upgrade the fiber infrastructure. This scaled transceiver architecture can be implemented via a single SKU for both PICA and PICB. This architecture is interoperable with transceivers similar to FIG. 4A that support the same wavelength band pairs, which could simplify the upgrade process where two single-fiber transceivers on the same rack can be incrementally swapped out for a single transceiver supporting this quad-fiber configuration.

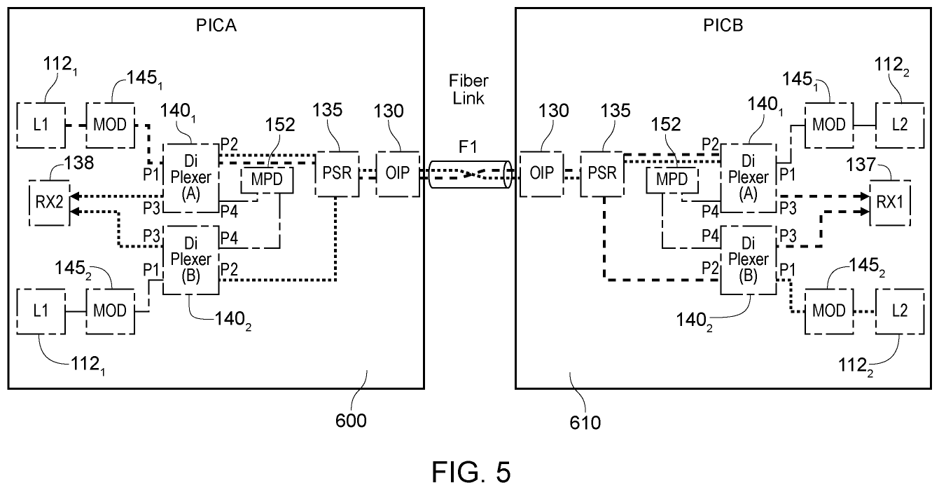

FIG. 5 shows another embodiment in which PICA 600 connects a set of redundant Band-1 lasers and modulators to the diplexer A/B ports diagonally opposite to the port on which the MPD is located. In particular, light from laser 112₁ is directed to modulator 145₁, which connects to port 1 of diplexer 140₁. Likewise, light from laser 112₂ is directed to modulator 145₂, which connects to port P1 of diplexer 140₂. Similarly, PICB 610 includes a set of redundant Band-2 lasers and modulators that are connected to its respective diplexer A/B ports diagonally opposed to the MPD port. This PIC architecture provides full laser and modulator redundancy, which can be exercised in the event of laser or modulator failure. This embodiment requires a unique SKU for each PIC variant and requires two sets of DC and RF electronic circuitry for the spare laser and modulator (unless the electronic ASIC is able to accommodate analog switches to reallocate electronic resources accordingly).

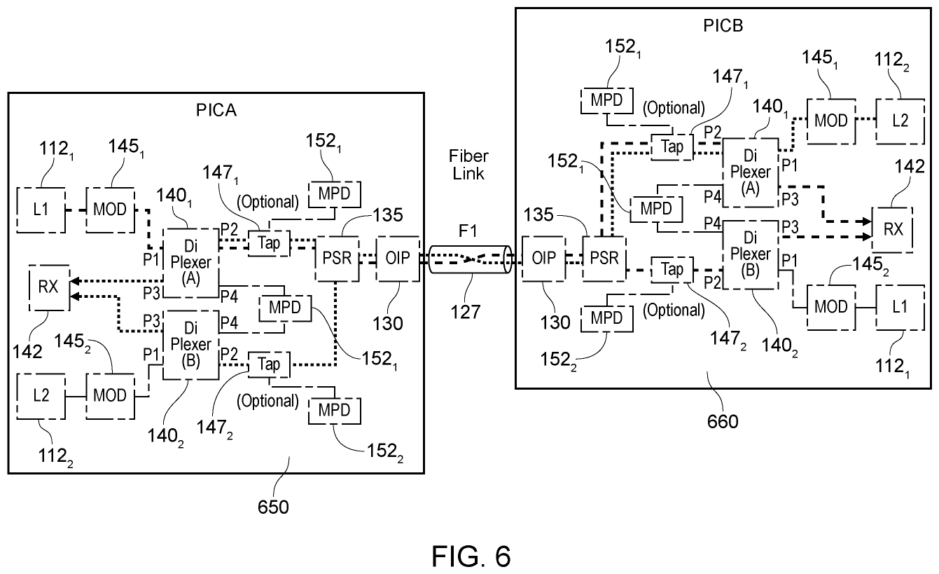

FIG. 6 shows another embodiment in which laser and modulator pairs from Band-1 and -2 are independently connected to port 1 of each of the diplexers. In this configuration, optical path redundancy can be provided in the event of a laser failure. For example, PICA 650 may be configured for Band-1 transmission (via L1 112₁) while receiving Band-2 signals (via L2 112₂) from PICB 660. Conversely, PICB 660 receives Band-1 signals from PICA 650 while configured for Band-2 transmission. If laser failure is observed on either PICA 650 or PICB 660, the transceiver pairs can be reconfigured to switch transmission to the laser on the alternate band (L2 112₂ transmission for PICA and L1 112₁ transmission for PICB). This architecture benefits from only requiring a single SKU for the transceiver pair. The receiver in this configuration needs to be explicitly designed to be able to receive signals and detect signals from both Bands-1 and -2. This is achievable by employing resonant DWDM-demultiplexers that can be reconfigured for the secondary band via tuning (as described in U.S. patent application Ser. No. 18/217,956). This excess tuning (observed during band reassignment) may be minimized if the DWDM is designed to closely match the frequency separation of Band-1 and Band-2. This architecture requires an extra set of electronics corresponding to the spare laser and modulator unless it can be reallocated via analog switches in an ASIC.

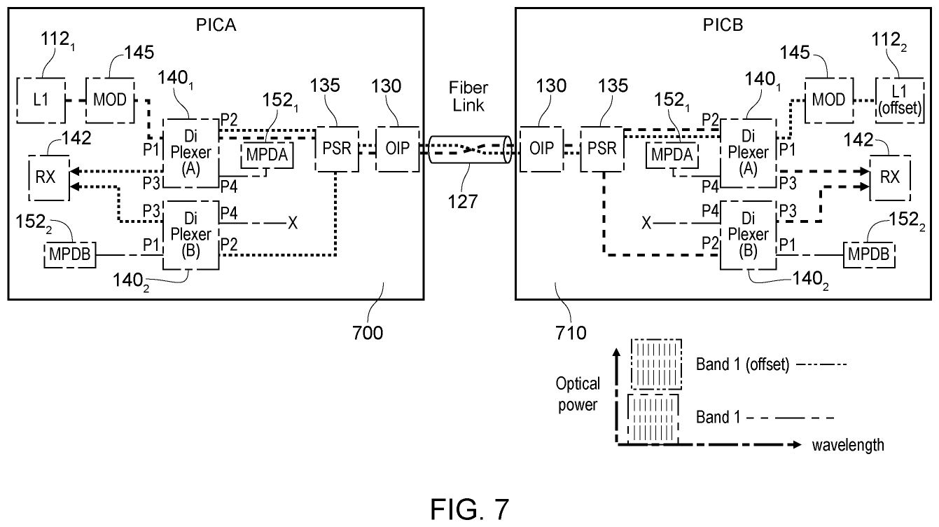

FIG. 7 shows another embodiment in which the bidirectional transceiver pair is implemented using identical wavelength bands in the transmit and receive PICs. The laser 112₁ in PICB 710 is configured to transmit on a wavelength grid that is offset from the wavelength grid of the laser 112₁ in PICA 700. This offset is equivalent to ½ the wavelength channel spacing (Δv). In this example the diplexer is implemented using the AMZI deinterleaver configuration described in FIG. 1C, designed with a similar free spectral range (FSR) equal to 1×Δv. This wavelength configuration ensures that counterpropagating signals are spatially separated with sufficient suppression at the diplexer. A leader-follower scheme needs to be implemented such that, for example, PICA 700 is designated as the wavelength reference while the laser on PICB 710 is configured to be offset by ½×Δv relative to the PICA wavelength grid via index tuning of the laser and modulator center wavelength. Furthermore, PICA 700 and PICB 710 are designed to share a common SKU.

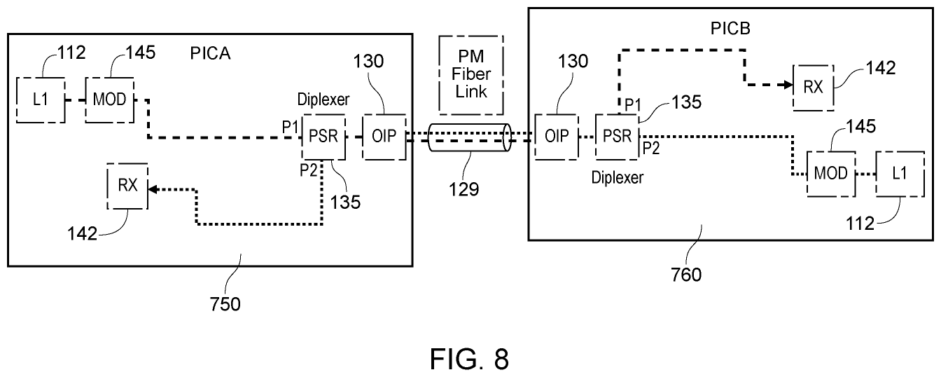

FIG. 8 illustrates another embodiment in which a polarization-maintaining (PM) fiber link 129 interconnects the transceiver pair, and diplexer 135 is implemented using a polarization splitter and rotator (PSR). In this embodiment, the optical interface port (OIP) 130 and PSR 135 may be realized using a variety of implementations, including, for example, a diced and polished end facet in combination with a PSR, or an etched end facet in combination with a PSR, each of which may be configured in a manner similar to that described in Wesley D. Sacher, Tymon Barwicz, Benjamin J. F. Taylor, and Joyce K. S. Poon, “Polarization rotator-splitters in standard active silicon photonics platforms,” Optics Express, vol. 22, pp. 3777-3786 (2014), or alternatively a two-dimensional grating coupler configured for polarization handling and optical coupling, such as described in B. Chen, X. Zhang, J. Hu, Y. Zhu, X. Cai, P. Chen, and L. Liu, “Two-dimensional grating coupler on silicon with a high coupling efficiency and a low polarization-dependent loss,” Optics Express, vol. 28, pp. 4001-4009 (2020).

The architecture shown in FIG. 8 requires two unique SKUs per transceiver pair. In the design of PICA 750, the transmitter block (comprising L1 112 and modulator 145 is connected to port P1 of PSR 135, which transmits in the TE polarization when coupled to the polarization maintaining fiber link 129. Additionally, RX 142 in PICA receives signals from port 2 of PSR 135, which corresponds to optical signals traveling in the TM polarization state within the polarization maintaining fiber link 129. Conversely, PICB 760 transmits and receives on the PSR ports corresponding to orthogonal polarization paths. For example, PICB 760 transmits through port P2 of PSR 135 while receiving optical signals on port P1. In this configuration optical signals are sent and received using a common wavelength band between the transceiver pair while offering true bidirectional duplexing.

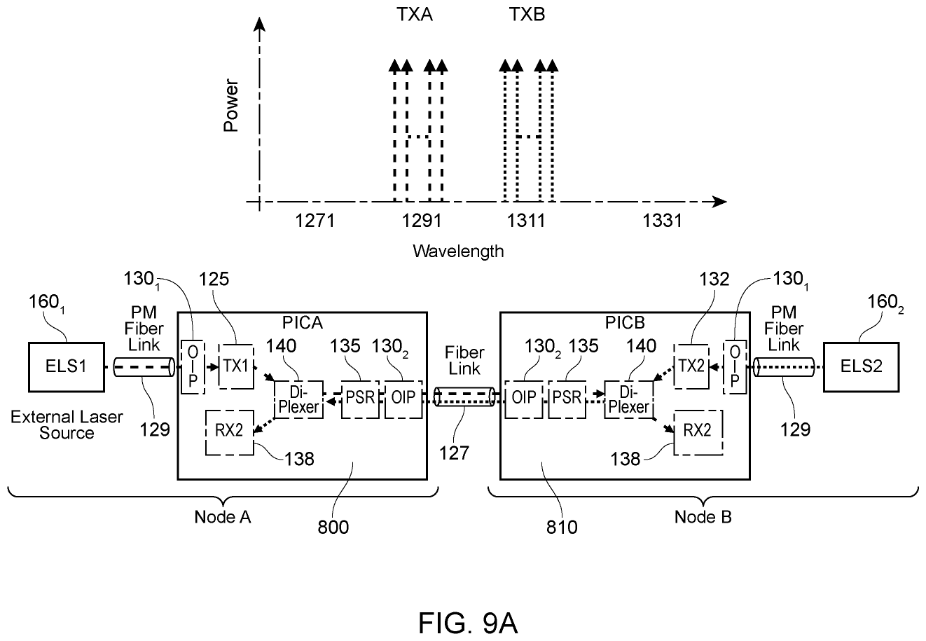

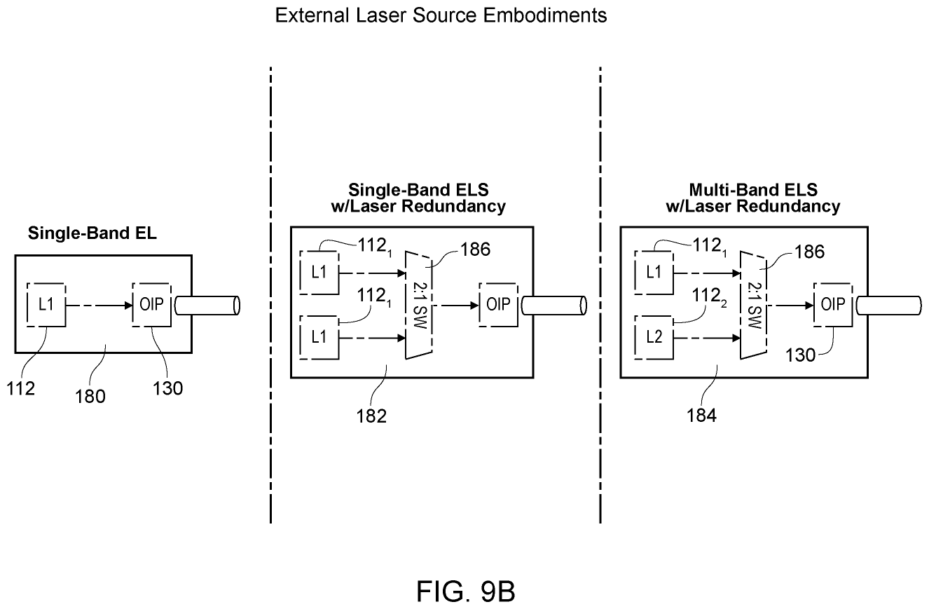

In another embodiment, the architectures above may be implemented using system-level configurations in which the laser comb source is situated external to the transceiver PICs. FIG. 9A is a schematic diagram that shows the laser comb sources located within External Laser Source (ELS) modules 1601 and 1602 that connect to the respective PICs via a polarization maintaining (PM) fiber. The ELS modules may be implemented as external optical modules compliant to a standardized formfactor such as ELSFP, for example. The transmitter blocks in the PICs exclude the comb source laser and include optical interface ports (OIP) 1301 and 1302 to receive the output from the ELS modules.

FIG. 9B shows examples of different implementations for the ELS modules. In one embodiment (left), the ELS 180 includes a comb source 112 spanning a single wavelength band. The output of this comb source is directed towards an OIP 130 that is coupled to a PM fiber. This architecture requires a unique SKU depending on which CWDM wavelength grid is supported (4 SKUs for CWDM4 and 8 SKUs for CWDM8).

In another embodiment (FIG. 9B, center), the ELS 182 includes two comb source lasers L1 112₁ that are selectable via a 2:1 optical switch whose output is routed to the OIP, which is optically coupled to a PM fiber. Only one of the comb sources is enabled during operation and provides enhanced reliability via laser redundancy if one laser were to exhibit signs of degradation. In this embodiment, the secondary comb source is enabled, and the primary laser is decommissioned. This architecture requires a unique SKU depending on which CWDM wavelength grid is supported (4 SKUs for CWDM4 and 8 SKUs for CWDM8).

In another embodiment (FIG. 9B, right), the ELS 184 includes a multi-band design where comb sources 112₁ and 112₂ from disparate CWDM wavelength grids are selectable via a 2:1 optical switch 186. The switch's output is routed to the OIP 130, which is optically coupled to a PM fiber. In this configuration, only one of the comb laser sources is enabled during operation. If the primary comb laser from Node A were to fail, its corresponding ELS could be reconfigured to transmit using the secondary wavelength band. Then, the ELS from Node B needs to be reconfigured to transmit using its alternate wavelength band. This architecture only requires a single SKU. The transceiver PICs utilizing this ELS needs to be (i) designed with components that could span the two wavelength bands; (ii) designed with an AMZI-based diplexer that can be reconfigured via thermal index tuning; and (iii) notified of the band swap to facilitate a quick reconfiguration. In some cases, this embodiment may use an optical multiplexer instead of the optical switch to simultaneously transmit Bands-1 and -2. This configuration allows the transceiver PICs to support multiple bands without increasing the ELS fiber count. Furthermore, the transceiver PICs include a corresponding optical de-multiplexer to spatially separate the signals from disparate wavelength bands before routing to the appropriate transmitter block. The optical multiplexer may be implemented as an AMZI interleaver. Alternatively, a PSR can be utilized as a polarization multiplexer where the two bands are transmitted via the PM fiber in orthogonal polarization states

The PIC architectures shown in FIGS. 2-6 also may employ external ELS modules. The PIC architecture shown in FIG. 7 also may be configured with an external ELS module. However, it requires network-level coordination to ensure that the frequency offset is correctly applied to each ELS module (and possibly each transceiver PIC). Furthermore, any wavelength control circuitry and logic would need to be implemented within each ELS module. Moreover, the implementations described herein may be selected based on any of a variety of factors including, for example, a desired coupling efficiency, polarization performance, and fabrication considerations while remaining within the scope of the disclosed architecture.er,

It is to be understood that the present disclosure teaches only examples of embodiments in accordance with the present disclosures and that many variations of these embodiments can easily be devised by those skilled in the art after reading this disclosure and that the scope of the present invention is to be determined by the following claims.

1. A bidirectional optical transceiver, comprising:
a transmitter module, including,
at least one dense wavelength division multiplexed (DWDM) optical comb laser source, and
a plurality of optical modulators configured to modulate respective DWDM wavelength channels derived from the at least one DWDM optical comb source;
a receiver module including,
a plurality of wavelength-selective optical filters matched to the DWDM wavelength channels, and
a plurality of photodetectors optically coupled to respective ones of the wavelength-selective optical filters;
an optical interface port configured for optical coupling to a single optical fiber; and
a diplexer optically coupled between the transmitter module, the receiver module, and the optical interface port,
wherein the diplexer is configured to direct optical signals propagating in a first direction on the single optical fiber to the receiver module and to direct optical signals generated by the transmitter module to propagate in an opposite direction on the single optical fiber, and
wherein the transmitter module and the receiver module are configured to operate on different sets of DWDM wavelength channels such that bidirectional optical communication is supported over the single optical fiber without use of an optical circulator.

2. The bidirectional optical transceiver of claim 1, wherein the diplexer comprises one or more asymmetric Mach-Zehnder interferometers (AMZIs).

3. The bidirectional optical transceiver of claim 1, wherein the diplexer comprises a passive contra-directional filter (CDF).

4. The bidirectional optical transceiver of claim 1, wherein the different sets of DWDM wavelength channels are centered in different coarse wavelength division multiplexed (CWDM) bands.

5. The bidirectional optical transceiver of claim 4, wherein the CWDM bands are selected from a CWDM4 grid having approximately 20 nm spacing or a CWDM8 grid having approximately 10 nm spacing.

6. The bidirectional optical transceiver of claim 1, wherein the plurality of optical modulators comprises an array of micro-ring modulators having resonant wavelengths matched to respective DWDM wavelength channels.

7. The bidirectional optical transceiver of claim 1, wherein the plurality of optical modulators comprises Mach-Zehnder modulators or electro-absorption modulators.

8. The bidirectional optical transceiver of claim 1, further comprising a polarization splitter and rotator disposed between the optical interface port and the receiver module

9. The bidirectional optical transceiver of claim 1, wherein the transmitter module comprises at least two DWDM optical comb input source selectively coupled to the plurality of optical modulators to provide laser redundancy.

10. The bidirectional optical transceiver of claim 9, wherein the at least two DWDM optical comb input sources are selectively coupled using a tunable Mach-Zehnder interferometer acting as an optical switch.

11. The bidirectional optical transceiver of claim 9, wherein the bidirectional optical transceiver is configurable to selectively transmit optical signals on either of the different sets of DWDM wavelength channels and to receive optical signals on the other of the different sets.

12. The bidirectional optical transceiver of claim 1, wherein the transmitter module is configured to transmit optical signals on a DWDM wavelength grid that is offset by approximately one-half of a channel spacing relative to a counter-propagating DWDM wavelength grid.

13. The bidirectional optical transceiver of claim 1, wherein the at least one DWDM optical laser comb source is an external DWDM optical laser source module.

14. The bidirectional optical transceiver of claim 1, wherein the transmitter module and the receiver module are configured to operate across more than two wavelength bands.

15. The bidirectional optical transceiver of claim 1, further comprising a polarization splitter and rotator configured to separate an optical signal into a first polarization path and a second polarization path, wherein the diplexer comprises a first diplexer disposed in the first polarization path and a second diplexer disposed in the second polarization path.

16. The bidirectional optical transceiver of claim 15, wherein each of the first diplexer and the second diplexer is configured to transmit optical signals in a first wavelength band and to receive optical signals in a second wavelength band different from the first wavelength band.

17. The bidirectional optical transceiver of claim 15, wherein the first diplexer and the second diplexer are independently tunable to adjust wavelength alignment for their respective polarization paths.

18. The bidirectional optical transceiver of claim 15, wherein the transmitter module comprises at least two selectable DWDM optical laser comb sources configured to enable wavelength-band swapping.

19. The bidirectional optical transceiver of claim 1, wherein the transmitter module comprises a single DWDM optical laser comb source and excludes redundant optical laser comb sources.

20. The bidirectional optical transceiver of claim 14, further comprising a second optical interface port and a second diplexer, wherein the transmitter module and the receiver module are configured to operate over a first wavelength-band pair on a first fiber link and a second wavelength-band pair on a second fiber link.

21. The bidirectional optical transceiver of claim 20, wherein the transmitter module and the receiver module are configured to operate across four wavelength bands forming two bidirectional wavelength-band pairs.

22. The bidirectional optical transceiver of claim 9, wherein the transmitter module further comprises a primary laser-modulator path and a redundant laser-modulator path optically coupled to the diplexer via distinct optical routing paths.

23. The bidirectional optical transceiver of claim 9, wherein DWDM optical laser comb sources corresponding to different wavelength bands are selectively coupled to a common diplexer port to enable transmission band reassignment in response to a laser failure.

24. The bidirectional optical transceiver of claim 12, wherein the wavelength-selective diplexer comprises an interleaver configured to spatially separate the offset wavelength grids.

25. The bidirectional optical transceiver of claim 8, wherein the polarization splitter and rotator are configured to route transmit optical signals and receive optical signals in orthogonal polarization states.

26. The bidirectional optical transceiver of claim 1, wherein the transmitter module, receiver module, diplexer, optical interface port are formed as a common photonic integrated circuit (PIC).

27. The bidirectional optical transceiver of claim 1, wherein the receiver module, diplexer, optical interface port are formed as a common photonic integrated circuit (PIC).

28. The bidirectional optical transceiver of claim 26, further comprising an optical input port formed on the common PIC and being configured to receive a DWDM optical comb from an external laser source module.

29. The bidirectional optical transceiver of claim 28, wherein the external laser source module comprises at least two selectable DWDM optical comb sources coupled through an optical switch.

30. The bidirectional optical transceiver of claim 28, wherein the external laser source module comprises DWDM optical comb sources centered in different wavelength bands selectable to support wavelength-band reassignment.

31. The bidirectional optical transceiver of claim 28, wherein the external laser source module further comprises an optical multiplexer configured to simultaneously provide optical carriers from multiple wavelength bands to the optical input port.

32. An optical communication system, comprising:
at least first and second transceiver modules optically coupled by a single optical fiber;
wherein each transceiver module includes:
a transmitter configured to transmit a plurality of dense wavelength division multiplexed (DWDM) optical channels within a first wavelength set;
a receiver configured to receive a plurality of DWDM optical channels within a second wavelength set different from the first wavelength set and a diplexer optically coupling the transmitter and the receiver to the single optical fiber;
wherein the first transceiver module is configured to transmit optical signals toward the second transceiver module using a first set of DWDM wavelength channels and receive optical signals from the second transceiver module using a second set of DWDM wavelength channels; and
wherein the second transceiver module is configured to transmit optical signals toward the first transceiver module using the second set of DWDM wavelength channels and receive optical signals using the first set of DWDM wavelength channels.
